(19) United States
(12) Patent Application Publication
(10) Pub. No.: US 2025/0047462 A1
(43) Pub. Date: Feb. 6, 2025

(54) Data security detection method and device for privacy computing

(71) Applicant: Alipay (Hangzhou) Information Technology Co., Ltd., Hangzhou (CN)

(72) Inventor: Yufei LU, Hangzhou (CN)

(21) Appl. No.: 18/771,128

(22) Filed: Jul. 12, 2024

(30) Foreign Application Priority Data
Jul. 14, 2023 (CN) 2023108733175

(51) Int. Cl. H04L 9/00; H04L 9/06

(52) U.S. Cl. CPC H04L 9/008; H04L 9/0618

(57) ABSTRACT

This specification provides a data security detection method and device for privacy-preserving computing. The privacy-preserving computing includes a homomorphic encryption operation, a public key of the homomorphic encryption operation is in a public state, a private key is held by a first party, the private key includes a first private key value, and a decryption process of the homomorphic encryption is completed based on a modulo operation performed on the first private key value. The first party decrypts the second encrypted value by using the private key, to obtain a target plaintext value. The first party determines whether the target plaintext value is greater than a preset value, and if the target plaintext value is greater than the preset value, determines that there is a risk of a plaintext overflow attack, and ends current computing.

### TECHNICAL FIELD

One or more embodiments of this specification relate to the data privacy security field, and in particular, to a data security detection method and device for privacy-preserving computing.

### BACKGROUND

In an Internet big data scenario, a large amount of data is deposited and accumulated on each platform, and includes privacy data related to personal information of a user. Some solutions for performing joint data processing through privacy-preserving computing are provided, to increase data value, and protect privacy data security. For example, federated learning is a common joint modeling solution. Specifically, federated learning is a distributed machine learning technology. A core idea of federated learning is to perform distributed model training among a plurality of data sources that have local data, and construct a global model based on virtually fused data only by exchanging a model parameter or an intermediate result without a need to exchange local individual or sample data, to achieve a balance between data privacy preservation and data sharing computing, so that data is available but invisible.

In a plurality of joint data processing scenarios including federated learning, privacy data needs to be processed and exchanged by using a privacy-preserving computing technology such as multi-party computation (MPC) or homomorphic encryption, and security of an underlying cryptosystem is crucial to system-wide security. If a security vulnerability exists in an algorithm for implementing homomorphic encryption, the algorithm may be attacked, and privacy data is disclosed. Therefore, it is expected that security detection can be performed on data for privacy-preserving computing to which homomorphic encryption is applied, to improve data security and privacy preservation.

### SUMMARY

One or more embodiments of this specification describe a data privacy security detection solution for privacy-preserving computing, to accurately and efficiently detect a plaintext overflow attack in a homomorphic encryption process, and improve data privacy security.

According to a first aspect, a data security detection method for privacy-preserving computing is provided. The privacy-preserving computing includes a homomorphic encryption operation, a public key of the homomorphic encryption operation is in a public state, a private key is held by a first party, the private key includes a first private key value, a decryption process of the homomorphic encryption is completed based on a modulo operation performed on the first private key value, and the method is performed by the first party, and includes:
receiving an operation request sent by a second party, where the operation request includes a first encrypted value obtained through encryption by using the public key;
determining a second encrypted value to be decrypted, where the second encrypted value is obtained based on the first encrypted value;
decrypting the second encrypted value by using the private key, to obtain a target plaintext value; and
determining whether the target plaintext value is greater than a preset value, and ending current computing if the target plaintext value is greater than the preset value.

In an example, the preset value is greater than a data range of service data, and is less than the first private key value by a preset ratio.

In a specific example, a number of bits of the first private key value is greater than 500, and a number of bits of the preset value is 64 or 128.

In an example, an OU algorithm is used for the homomorphic encryption.

According to an embodiment, the determining a second encrypted value to be decrypted includes: determining the first encrypted value as the second encrypted value.

According to another embodiment, the determining a second encrypted value to be decrypted includes: performing a target homomorphic operation based on the first encrypted value, to obtain the second encrypted value.

Further, in an example, an algorithm for the target homomorphic operation is specified by the second party.

In an implementation, the method further includes: if it is determined that the target plaintext value is not greater than the preset value, returning the target plaintext value to the second party, or performing a further operation based on the target plaintext value.

In an example, the method further includes: sending prompt information if the target plaintext value is greater than the preset value. The prompt information is used to indicate that there is a risk of a plaintext overflow attack.

According to a second aspect, a data security detection device for privacy-preserving computing is provided. The privacy-preserving computing includes a homomorphic encryption operation, a public key of the homomorphic encryption operation is in a public state, a private key is held by a first party, the private key includes a first private key value, a decryption process of the homomorphic encryption is completed based on a modulo operation performed on the first private key value, and the device is deployed in the first party, and includes:
a receiving unit, configured to receive an operation request sent by a second party, where the operation request includes a first encrypted value obtained through encryption by using the public key;
a determining unit, configured to determine a second encrypted value to be decrypted, where the second encrypted value is obtained based on the first encrypted value;
a decryption unit, configured to decrypt the second encrypted value by using the private key, to obtain a target plaintext value; and
a judgment unit, configured to: determine whether the target plaintext value is greater than a preset value, and end current computing if the target plaintext value is greater than the preset value.

According to a third aspect, a computer-readable storage medium is provided. The computer-readable storage medium stores a computer program, and when the computer program is executed on a computer, the computer is enabled to perform the method in the first aspect.

According to a fourth aspect, a computing device is provided, including a memory and a processor. The memory stores executable code, and when the processor executes the executable code, the method in the first aspect is implemented.

In the embodiments of this specification, a data security detection method for privacy-preserving computing is provided, and is applicable to a process of a homomorphic encryption algorithm in which decryption is performed by performing a modulo operation on a private key value. According to the method, a second encrypted value to be decrypted is first determined based on a first encrypted value provided by another party, and the second encrypted value is decrypted to obtain a plaintext value. Whether the plaintext value is greater than a preset value is determined; and if the plaintext value is greater than the preset value, it is considered that there is a plaintext overflow attack, and current computing is ended. In this solution, reasonability of a range of a decryption result is determined in a decryption step, and plaintext overflow attacks sent in various manners can be detected, to improve data security for privacy-preserving computing.

### BRIEF DESCRIPTION OF DRAWINGS

To describe the technical solutions in the embodiments of the present invention more clearly, the following briefly describes the accompanying drawings needed for describing the embodiments. Clearly, the accompanying drawings in the following descriptions show merely some embodiments of the present invention, and a person of ordinary skill in the art can still derive other drawings from these accompanying drawings without creative efforts.

FIG. 1 shows a process and a principle of a plaintext overflow attack;

FIG. 2 is a schematic diagram of data security detection according to an embodiment;

FIG. 3 is a flowchart of a data security detection method for privacy-preserving computing according to an embodiment; and

FIG. 4 is a schematic block diagram of a data security detection device deployed in a first party.

### DESCRIPTION OF EMBODIMENTS

The following describes the solutions provided in this specification with reference to the accompanying drawings.

As described above, privacy data needs to be processed and exchanged through privacy-preserving computing in a joint data processing scenario related to the privacy data. Homomorphic encryption is an implementation of privacy-preserving computing.

Homomorphic encryption is an encryption form, and allows a person to perform an algebraic operation in a specific form on a ciphertext, to still obtain an encrypted result. A result obtained by decrypting the encrypted result is the same as a result obtained by performing the same operation on a plaintext. In other words, such a technology allows the person to perform algebraic computing on encrypted data and obtain a correct result, without a need to decrypt the data throughout a processing process.

For example, if an electronic payment platform A has transaction data a and a bank institution B has credit data b, both the data a and the data b are privacy data of corresponding institutions. The electronic payment platform A can encrypt the transaction data a based on a homomorphic encryption algorithm, to obtain Enc(a). Then, the electronic payment platform A sends the ciphertext Enc(a) to the bank institution B. The bank institution B directly performs a specific operation P on Enc(a) and the local data b. An obtained computing result is still a ciphertext. In this process, the bank institution B cannot perceive the original data a of the electronic payment platform A. Finally, the bank institution B sends the ciphertext of the computing result to the electronic payment platform A. The platform A decrypts the ciphertext by using a private key of the platform A, to obtain a final computing result. The computing result is consistent with a result obtained by directly performing the operation P on the plaintext data a and b. In the above-mentioned process, the electronic payment platform A and the bank institution B cannot infer data of each other, but obtain the computing result, so that data is “available but invisible”, to well satisfy a service requirement.

Homomorphic encryption includes fully homomorphic encryption (briefly referred to as FHE below) and partially homomorphic encryption (briefly referred to as PHE below) based on a type of a ciphertext operation supported by homomorphic encryption. A fully homomorphic encryption algorithm supports to perform both addition and multiplication homomorphic operations on a ciphertext, that is, satisfies both of the following equations: Enc(a)+Enc(b)=Enc(a+b), and Enc(a)*Enc(b)=Enc(a*b). In terms of an operation form, FHE supports operations such as a ciphertext+plaintext operation, a ciphertext+ciphertext operation, a ciphertext*plaintext operation, and a ciphertext*ciphertext operation.

A partially homomorphic encryption algorithm supports to perform only one operation, for example, an addition operation or a multiplication operation on a ciphertext. For example, a Paillier algorithm and an Okamoto-Uchiyama (OU) algorithm are an addition homomorphic operation, and satisfy Enc(a)+Enc(b)=Enc(a+b); and RSA is a multiplication homomorphic encryption algorithm, and satisfies Enc(a)*Enc(b)=Enc(a*b). In terms of an operation form, the addition homomorphic operation supports operations such as a ciphertext+plaintext operation, a ciphertext+ciphertext operation, and a ciphertext*plaintext operation.

Usually, a full algorithm process of the homomorphic encryption algorithm includes operations in the following phases:
1. Keygen: A public key and a private key for encryption are generated.
2. Encrypt: Encryption is performed. The public key and a plaintext are input, to obtain a ciphertext.
3. Evaluate: A ciphertext operation is performed. For example, three operations of a ciphertext+ciphertext operation, a ciphertext+plaintext operation, and a ciphertext*plaintext operation can be performed in the addition homomorphic algorithm.
4. Decrypt: Decryption is performed. The private key and the ciphertext are input, to obtain the plaintext.

The following describes specific operations in the foregoing phases by using the Okamoto-Uchiyama (OU) algorithm as an example.

1. In a Keygen key generation phase, two large prime numbers p and q are selected, and n is computed based on Formula (1):

$$n = {p}^{2} * q \qquad ( 1 )$$

Then, a generator g is randomly selected, g<n is satisfied, and g^{P-1}≈1 mod p². Then, h is computed based on Formula (2):

$$h = {g}^{n} mod n \qquad ( 2 )$$

A public key PubKey=(n, g, h) and a private key SecKey=(p, q) are computed.

2. In an encryption phase, a message m to be encrypted is input, and m<p. A positive integer r (r<n) is randomly selected, and a ciphertext c is computed based on Formula (3):

$$c = {g}^{m} {h}^{r} mod n \qquad ( 3 )$$

3. In a ciphertext operation phase, a plurality of ciphertext operations can be performed.

Specifically, for the ciphertext+ciphertext operation, when two ciphertexts c₁=Enc(m₁) and c₂=Enc(m₂) are given, a ciphertext c₃ obtained after a homomorphic operation can be computed based on Formula (4):

$${c}_{3} = {c}_{1} {c}_{2} mod n \qquad ( 4 )$$

For the ciphertext+plaintext operation, when a ciphertext c₁=Enc(m₁) and a plaintext m₂ are given, a ciphertext c₃ obtained after a homomorphic operation can be computed based on Formula (5):

$${c}_{3} = {c}_{1} {g}^{{m}_{2}} mod n \qquad ( 5 )$$

For the ciphertext*plaintext operation, when a ciphertext c₁=Enc(m₁) and a plaintext m₂ are given, a ciphertext c₃ obtained after a homomorphic operation can be computed based on Formula (6):

$${c}_{3} = {c}_{1}^{{m}_{2}} mod n \qquad ( 6 )$$

4. In a decryption phase, when the given ciphertext c is input,

$$L ( x ) = \frac{x - 1}{p}$$

is defined, and a plaintext m can be computed based on Formula (7):

$$m = \frac{L ( {c}^{p - 1} mod {p}^{2} )}{L ( {g}^{p - 1} mod {p}^{2} )} mod p \qquad ( 7 )$$

In actual use, 2048 bits are usually selected as a size of a key of the OU algorithm. In other words, n is a size of 2048 bits (in binary). Correspondingly, the two large prime numbers p and q are approximately at least 683 bits.

It can be learned from Formula (7) that when decryption is performed based on the OU algorithm, a value modulo p operation needs to be performed. It can be learned that a plaintext value range space is [0, p). In other words, if the plaintext m=p+1, a number obtained after encryption and decryption performed based on OU is 1.

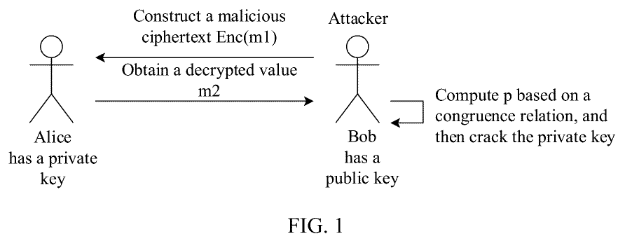

For the homomorphic encryption algorithm, for example, the OU algorithm in which a decryption operation relates to the modulo operation performed on the private key value p, there may be a plaintext overflow attack. FIG. 1 shows a process and a principle of a plaintext overflow attack.

As shown in FIG. 1, it is assumed that Alice has a private key (p, q), and a public key (n, g, h) is disclosed. Therefore, an attacker Bob can obtain the public key. To carry out an attack, the attacker Bob can select a plaintext greater than p: m1>p. The plaintext is encrypted, to construct a malicious ciphertext Enc(m1). Then, Bob requests, in various manners, Alice to perform decryption, to obtain a decrypted result m2.

Clearly, m1>p, m2<p, and m2≡m1 mod p. In other words, m1 is congruent to m2 modulo p, and m1−m2 is a multiple of p. Therefore, p can be obtained by computing a greatest common divisor gcd(m1−m2, n). After p is obtained, the attacker Bob can obtain q based on Formula (1) and n that is known, to restore the entire private key. Once the attacker obtains the entire private key, the private key may be used to steal privacy data of another party.

For the plaintext overflow attack, a conventional defense method is usually to perform detection in the encryption phase. Specifically, a toolkit or an independent security detection tool of the homomorphic encryption algorithm detects whether the input plaintext m is greater than p. If m is greater than p, encryption is rejected. Because only the public key is required in an encryption process, the toolkit of the encryption algorithm usually does not learn of an exact value of p in the private key. However, an approximate range of p can be learned of based on a value of n. For example, p is a large integer of approximately 683 bits. Therefore, when the plaintext m exceeds a specific number of bits, it can be considered that the plaintext m is greater than the private key value p, and encryption can be rejected.

However, a vulnerability still exists in the above-mentioned defense method. The homomorphic encryption algorithm can support the ciphertext operation. Therefore, even if m is less than p during encryption, m still may be greater than or equal to p after several ciphertext operations, and an attack is still valid. That is, the attacker may bypass the above-mentioned defense method in the following manner. To be specific, the attacker Bob selects the plaintext m that is close to but less than p, and encrypts m to obtain c; and then requests Alice to perform t times of ciphertext addition (or one time of plaintext and ciphertext multiplication) on the ciphertext c, to satisfy m*t>p. Then, Bob obtains a decrypted value m2 in various manners, and computes gcd(m*t−m2, n), to obtain the private key value p. Therefore, such an attack cannot be effectively detected in the conventional defense method.

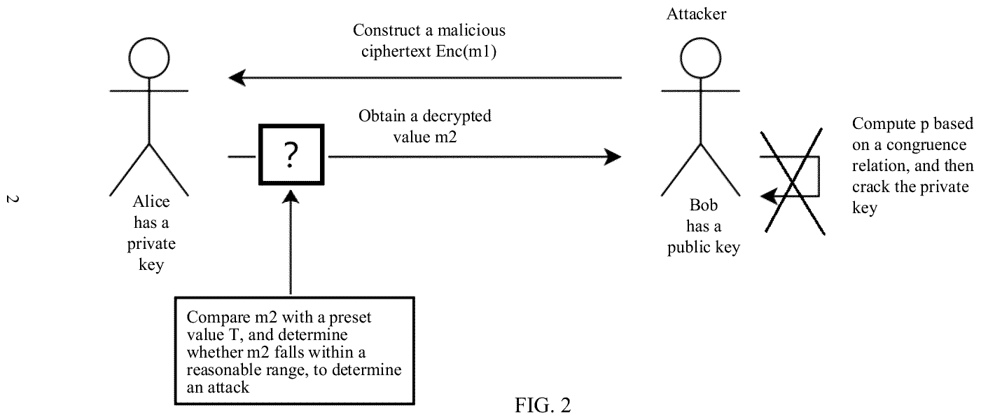

In view of this, in this embodiment of this specification, a new data privacy security detection method is provided. FIG. 2 is a schematic diagram of data security detection according to an embodiment. As shown in FIG. 2, instead of performing detection in an encryption phase, security detection is performed in a decryption phase in this solution. When it is determined that a plaintext obtained through decryption is greater than a reasonable range, it is determined that Bob is carrying out a plaintext overflow attack. Consequently, current computing is ended, and a current decryption result is no longer used. The following describes a specific implementation process of the above-mentioned concept.

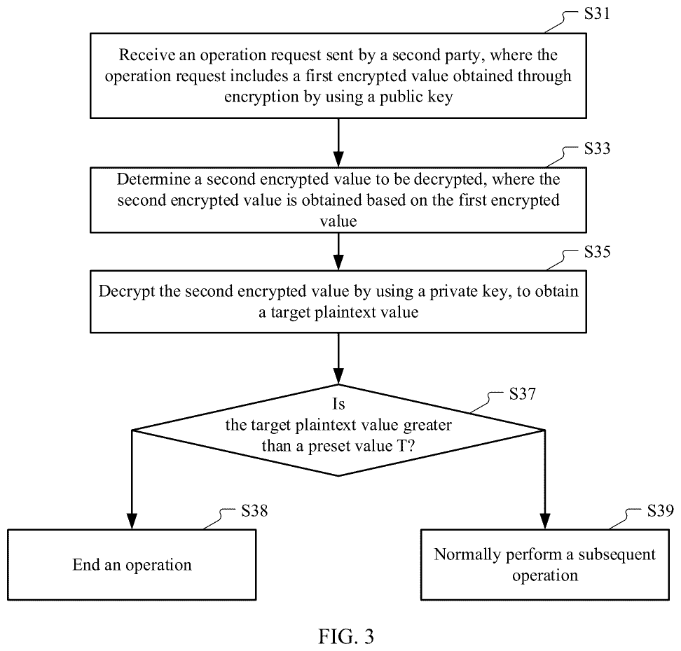

FIG. 3 is a flowchart of a data security detection method for privacy-preserving computing according to an embodiment. The privacy-preserving computing relates to at least a first party and a second party, and the first party and the second party can be implemented by using any apparatus, device, platform, or device cluster that has a computing or processing capability. In addition, an execution process of the privacy-preserving computing includes a homomorphic encryption operation. In other words, a computing protocol of the privacy-preserving computing can be a protocol of a homomorphic encryption algorithm, or can be another protocol for which a homomorphic encryption algorithm needs to be used in an implementation process. A public key PubKey and a private key SecKey of the homomorphic encryption algorithm are generated by the first party, the public key PubKey is disclosed externally, and the private key SecKey is only held by the first party. The private key SecKey includes a first private key value p, and a decryption process of homomorphic encryption is completed based on a modulo operation performed on the first private key value p. With reference to architectures in FIG. 1 and FIG. 2, the first party herein corresponds to Alice, and the second party corresponds to Bob. The method is performed by the first party that has the private key, and specifically, includes the following steps.

In step S31, the first party receives an operation request sent by the second party. The operation request includes a first encrypted value obtained through encryption by using the public key PubKey. The first encrypted value can be denoted as Enc(m1).

In step S33, the first party determines a second encrypted value Enc(m2) to be decrypted. The second encrypted value Enc(m2) is obtained based on the first encrypted value Enc(m1).

In an embodiment, the operation request sent by the second party in step S31 is to request the first party to decrypt the first encrypted value. In this case, the first party can directly determine the first encrypted value as the second encrypted value to be decrypted. That is, Enc(m2)=Enc(m1).

In another embodiment, the operation request sent by the second party in step S31 is to request the first party to perform a first homomorphic operation based on the first encrypted value and then perform decryption. The first homomorphic operation can be an operation specified by the second party, for example, multiplying a plaintext t learned of by the second party, or adding a plaintext m3 learned of by the second party. In this case, the first party can perform the first homomorphic operation based on the first encrypted value Enc(m1), to obtain the second encrypted value Enc(m2); and determine the second encrypted value Enc(m2) as a ciphertext to be decrypted.

In still another embodiment, the first party and the second party pre-agree about processing logic of joint data processing. In this case, the first party performs a second homomorphic operation corresponding to the processing logic based on the first encrypted value Enc(m1), to obtain the second encrypted value Enc(m2). For example, the first party and the second party each have feature values of some users for a specific feature. The two parties jointly compute information value (IV) or a weight of evidence (WOE) value of the feature based on a specific algorithm. In this case, the first encrypted value Enc(m1) sent by the second party theoretically needs to correspond to a ciphertext of some binned statistical data of a user of the second party for the feature value. The first party performs a homomorphic operation corresponding to a predetermined operation in a WOE computing process based on the ciphertext of the binned statistical data, to obtain the second encrypted value Enc(m2).

Then, in step S35, the first party decrypts the second encrypted value by using the private key, to obtain a target plaintext value m2. As described above, the decryption process is implemented based on the modulo operation performed on the first private key value p.

Next, in step S37, whether the target plaintext value m2 is greater than a preset value T is determined. If the target plaintext value m2 is greater than the preset value T, it is determined that there is a risk of a plaintext overflow attack. Therefore, step S38 is performed, to end current computing. Optionally, prompt information can be further sent. The prompt information is used to indicate that there is a risk of a plaintext overflow attack.

The preset value T corresponds to a reasonable range of service data, and can be determined based on an actual value range of the service data. Usually, the preset value is set to be greater than a data range of the service data, and is far less than the first private key value p. More specifically, the preset value T needs to be less than the first private key value p by a preset ratio, or a ratio of the preset value T to the first privacy value p needs to be less than a ratio threshold (for example, 0.001), so that the preset value T is far less than the first private key value p in an order of magnitude.

In practice, a large prime number (namely, the first private key value p) in the private key of homomorphic encryption is a very large number, and is usually greater than 500 bits. For example, in an OU algorithm, n in the public key is usually 2048 bits, and correspondingly, p is approximately 683 bits. Most service data is 8-bit floating-point numbers, relatively large data can have 16 bits, and service data has 32 bits in a rare case. In this case, the preset value T can be set to 2\hat{ }32, or 2\hat{ }64, or 2\hat{ }128 based on the range of the service data. During an operation, T can be simply set to 128 bits, because 2\hat{ }128 is large enough for the service data to satisfy a general service requirement.

The following demonstrates reasonability of determining the plaintext overflow attack based on the threshold T.

As described above, the first private key value p is a very large number. For example, in OU, p is approximately 683 bits. An attacker Bob does not learn of a specific value of p, but only learns that p is a 683-bit number. In this case, to carry out the plaintext overflow attack, Bob blindly guesses a very large number m1 (which is usually also 683 bits). In this case, there is a very large probability that computed m2=m1 mod p is still a very large number, and is far greater than 2\hat{ }128.

Specifically, if Bob randomly selects a number m1 near p (for example, within a range of 683 bits), m2 is a random number in a range of [0, p). To simplify a model, if m2 is evenly distributed in the range of [0, p), a probability of m2<2\hat{ }128 is ½\hat{ }(683−128), and is a number infinitely close to 0. The probability is small enough to be ignored. A more intuitive reason is that when it is determined that p is a very large number of 683 bits, and another large number m1 of 683 bits is randomly selected, an absolute value (namely, m2) of a difference between m1 and p is also necessarily a very large number.

Based on the above-mentioned analysis, because normal service data is far less than 2\hat{ }128, when a plaintext obtained through decryption is greater than 2\hat{ }128, it can be determined that there is a plaintext overflow attack, and a false detection probability is very low. In addition, as analyzed above, when the attacker really carries out the plaintext overflow attack, the plaintext obtained through decryption is almost necessarily greater than 2\hat{ }128, and this means that a probability of missed detection is also very low (which infinitely tends to 0 as described above).

Therefore, the preset value T is reasonably set, and the ciphertext obtained through decryption is compared with the preset value T, to determine whether a plaintext overflow attack occurs. When it is determined that an attack occurs, computing is stopped, and an alarm is given

In addition, if it is determined in step S37 that the target plaintext value m2 is not greater than the preset value T, step S39 is performed, to normally perform a subsequent step of privacy-preserving computing. In an embodiment, the subsequent step can be returning the target plaintext value m2 to the second party. In another embodiment, the target plaintext value is an intermediate result of a joint data processing task, for example, an intermediate result used to compute the WOE value. After the first party obtains the target plaintext value through decryption, the first party performs a further operation based on the target plaintext value.

It can be learned from the above-mentioned process that, regardless of a malicious ciphertext constructed by the attacker and a specified operation, a decryption step is an inevitable step for completing an attack. Reasonability of a range of a decryption result is determined in the decryption step, to detect plaintext overflow attacks sent in various manners.

It should be noted that, although the foregoing provides descriptions with reference to the OU algorithm, it can be understood that the above-mentioned concept is also applicable to another similar homomorphic encryption algorithm. There is a risk of a plaintext overflow attack provided that decryption is performed by performing a modulo operation on the private key value in the homomorphic encryption algorithm. According to the above-mentioned solution, occurrence of the plaintext overflow attack can be accurately detected, to improve data security for privacy-preserving computing.

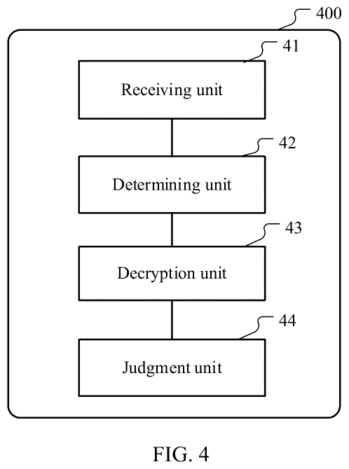

According to an embodiment in another aspect, a data security detection device for privacy-preserving computing is provided. The privacy-preserving computing includes a homomorphic encryption operation, a public key of the homomorphic encryption operation is in a public state, a private key is held by a first party, the private key includes a first private key value, and a decryption process of the homomorphic encryption is completed based on a modulo operation performed on the first private key value. The detection device is deployed in the first party, and the first party can be implemented as any device, platform, or device cluster that has a data storage, computing, or processing capability. FIG. 4 is a schematic block diagram of a data security detection device deployed in a first party. As shown in FIG. 4, the detection device 400 includes:
a receiving unit 41, configured to receive an operation request sent by a second party, where the operation request includes a first encrypted value obtained through encryption by using the public key;
a determining unit 42, configured to determine a second encrypted value to be decrypted, where the second encrypted value is obtained based on the first encrypted value;
a decryption unit 43, configured to decrypt the second encrypted value by using the private key, to obtain a target plaintext value; and
a judgment unit 44, configured to: determine whether the target plaintext value is greater than a preset value, and end current computing if the target plaintext value is greater than the preset value.

The preset value is greater than a data range of service data, and is less than the first private key value by a preset ratio.

In an embodiment, a number of bits of the first private key value is greater than 500, and a number of bits of the preset value is 64 or 128.

In a specific example, an OU algorithm is used for the homomorphic encryption.

According to an embodiment, the determining unit 42 is specifically configured to determine the first encrypted value as the second encrypted value.

According to another embodiment, the determining unit 42 is specifically configured to perform a target homomorphic operation based on the first encrypted value, to obtain the second encrypted value. Further, in an example, an algorithm for the target homomorphic operation is specified by the second party.

According to an embodiment, the device 400 further includes an execution unit (not shown), configured to: if it is determined that the target plaintext value is not greater than the preset value, return the target plaintext value to the second party, or perform a further operation based on the target plaintext value.

According to an example, the judgment unit 44 is further configured to send prompt information if the target plaintext value is greater than the preset value. The prompt information is used to indicate that there is a risk of a plaintext overflow attack.

The above-mentioned device can detect the plaintext overflow attack in homomorphic encryption more accurately and effectively, to improve data privacy security.

An embodiment of another aspect further provides a computer-readable storage medium. The computer-readable storage medium stores a computer program, and when the computer program is executed on a computer, the computer is enabled to perform the method described with reference to FIG. 3.

According to an embodiment of still another aspect, a computing device is further provided, including a memory and a processor. The memory stores executable code, and when the processor executes the executable code, the method described with reference to FIG. 3 is implemented.

A person skilled in the art should be aware that in the above-mentioned one or more examples, functions described in this application can be implemented by hardware, software, firmware, or any combination thereof. When the functions are implemented by software, the above-mentioned functions can be stored in a computer-readable medium or transmitted as one or more instructions or code in the computer-readable medium.

In the above-mentioned specific implementations, the objectives, technical solutions, and beneficial effects of the present invention are further described in detail. It should be understood that the above-mentioned descriptions are merely specific implementations of the present invention, but are not intended to limit the protection scope of the present invention. Any modification, equivalent replacement, improvement, or the like made based on the technical solutions of the present invention shall fall within the protection scope of the present invention.

1. A data security detection method for privacy-preserving computing, wherein the privacy-preserving computing comprises a homomorphic encryption operation, a public key of the homomorphic encryption operation is in a public state, a private key is held by a first party, the private key comprises a first private key value, a decryption process of the homomorphic encryption operation is completed based on a modulo operation performed on the first private key value, and the method is performed by the first party, and comprises:
receiving an operation request sent by a second party, wherein the operation request comprises a first encrypted value obtained through encryption by using the public key;
determining a second encrypted value to be decrypted, wherein the second encrypted value is obtained based on the first encrypted value;
decrypting the second encrypted value by using the private key, to obtain a target plaintext value; and
determining whether the target plaintext value is greater than a preset value, and ending current computing if the target plaintext value is greater than the preset value.

2. The method according to claim 1, wherein the preset value is greater than a data range of service data, and a ratio of the preset value to the first private key value is less than a preset ratio threshold.

3. The method according to claim 1, wherein a number of bits of the first private key value is greater than 500, and a number of bits of the preset value is 64 or 128.

4. The method according to claim 1, wherein an Okamoto-Uchiyama (OU) algorithm is used for the homomorphic encryption operation.

5. The method according to claim 1, wherein determining the second encrypted value to be decrypted comprises:
determining the first encrypted value as the second encrypted value.

6. The method according to claim 1, wherein determining the second encrypted value to be decrypted comprises:
performing a target homomorphic operation based on the first encrypted value, to obtain the second encrypted value.

7. The method according to claim 6, wherein an algorithm for the target homomorphic operation is specified by the second party.

8. The method according to claim 1, further comprising:
if it is determined that the target plaintext value is not greater than the preset value, returning the target plaintext value to the second party, or performing a further operation based on the target plaintext value.

9. The method according to claim 1, further comprising:
sending prompt information if the target plaintext value is greater than the preset value, wherein the prompt information is used to indicate that there is a risk of a plaintext overflow attack.

10. A non-transitory computer-readable storage medium, wherein the non-transitory computer-readable storage medium stores a computer program, which when executed by a processor causes the processor to:
receive an operation request sent by a second party, wherein the operation request comprises a first encrypted value obtained through encryption by using the public key;
determine a second encrypted value to be decrypted, wherein the second encrypted value is obtained based on the first encrypted value;
decrypt the second encrypted value by using the private key, to obtain a target plaintext value; and
determine whether the target plaintext value is greater than a preset value, and end current computing if the target plaintext value is greater than the preset value.

11. The non-transitory computer-readable storage medium according to claim 10, wherein the preset value is greater than a data range of service data, and a ratio of the preset value to the first private key value is less than a preset ratio threshold.

12. A computing device, comprising a memory and a processor, wherein the memory stores executable code, and when the processor executes the executable code, the computing device is caused to:
receive an operation request sent by a second party, wherein the operation request comprises a first encrypted value obtained through encryption by using the public key;
determine a second encrypted value to be decrypted, wherein the second encrypted value is obtained based on the first encrypted value;
decrypt the second encrypted value by using the private key, to obtain a target plaintext value; and
determine whether the target plaintext value is greater than a preset value, and end current computing if the target plaintext value is greater than the preset value.

13. The computing device according to claim 12, wherein the preset value is greater than a data range of service data, and a ratio of the preset value to the first private key value is less than a preset ratio threshold.

14. The computing device according to claim 12, wherein a number of bits of the first private key value is greater than 500, and a number of bits of the preset value is 64 or 128.

15. The computing device according to claim 12, wherein an Okamoto-Uchiyama (OU) algorithm is used for the homomorphic encryption operation.

16. The computing device according to claim 12, wherein the computing device being caused to determine the second encrypted value to be decrypted comprises being caused to:
determine the first encrypted value as the second encrypted value.

17. The computing device according to claim 12, wherein the computing device being caused to determine the second encrypted value to be decrypted comprises being caused to:
perform a target homomorphic operation based on the first encrypted value, to obtain the second encrypted value.

18. The computing device according to claim 17, wherein an algorithm for the target homomorphic operation is specified by the second party.

19. The computing device according to claim 12, wherein the computing device is further caused to:
if it is determined that the target plaintext value is not greater than the preset value, return the target plaintext value to the second party, or perform a further operation based on the target plaintext value.

20. The computing device according to claim 12, wherein the computing device is further caused to:
send prompt information if the target plaintext value is greater than the preset value, wherein the prompt information is used to indicate that there is a risk of a plaintext overflow attack.
